(19) United States
(12) Patent Application Publication
(10) Pub. No.: US 2008/0034833 A1
(43) Pub. Date: Feb. 14, 2008

(54) Optical Spectroscopy Instrument Response Correction

(76) Inventor: John Maier, Pittsburgh, PA (US)

Correspondence Address: MORGAN, LEWIS & BOCKIUS LLP, 1701 MARKET STREET, PHILADELPHIA, PA, 19103-2921, US

(21) Appl. No.: 11/831,088

(22) Filed: Jul. 31, 2007

Related U.S. Application Data
(60) Provisional application No. 60/834,721, filed on Jul. 31, 2006.

(51) Int. Cl. G12B 13/00; G01N 1/00

(52) U.S. Cl. 73/1.01; 356/36

(57) ABSTRACT

A system and method for correction of instrument response of an optical spectroscopy instrument using a Raman standard sample supplied by NIST (National Institute of Standards and Technology). The smoother side of the NIST sample is placed facing a light collection optics in the spectroscopy instrument, whereas the non-smooth or rough side remains away from the light collection optics, but in contact with a platform or sample placement surface in the spectroscopy instrument. An instrument response function is determined with the NIST sample so placed. Thereafter, spectra or spectral images of target samples obtained using the spectroscopy instrument are divided by the instrument response function to correct for imperfections in the response of the optical spectroscopy instrument. The target sample spectra may be non-Raman spectra. The optical spectroscopy instrument may be a gratings-based or a tunable filter based chemical imaging system.

### REFERENCE TO RELATED APPLICATION

The disclosure in the present application claims priority benefit under 35 U.S.C. § 119(e) of the U.S. Provisional Application No. 60/834,721, titled “Instrument Response Correction,” and filed on Jul. 31, 2006.

### BACKGROUND

1. Field of the Disclosure

The present disclosure generally relates to the field of optical instrument calibration and, more particularly, to a system and method for correction of instrument response of an optical instrument (e.g., a spectroscopic instrument) using a Raman standard from National Institute of Standards and Technology (NIST).

2. Brief Description of Related Art

An optical instrument in real life does not have a perfect or ideal performances for all wavelengths of light. This is true at an optical component level or at an optical system level. A real-life, imperfect optical component or system can be evaluated in terms of its transmission or detection performance, for instance. Furthermore, in the case where the component or system is stable, any deviations from the perfect or ideal performance can be measured and accounted for.

For the purpose of an example, consider a measurement of the imperfect spectral response of a real-life optical system. For this example, an ideal light source that produces the same number of photons at each wavelength may be used. If a spectrum of this source were taken with an ideal instrument, the spectrum would be a flat horizontal line as a function of wavelength. When this ideal source is used with an imperfect instrument, however, the measured spectrum is not a straight line. The real spectrum obtained from a perfect source with the same number of photons at each wavelength carries information about the instrument response of the real-world, imperfect optical instrument. In this example, the instrument response is the spectral response. In general, instrument response as a function of any number of parameters can be measured and corrected for.

In working with optical systems, the presence of the instrument response—i.e., a manifestation of an instrument's imperfections or deviations from the ideal response—is evident in both dispersive and imaging spectroscopy experiments. For example, in case of a dispersive spectroscopy measurement (e.g., measurement of a Raman spectrum) on a sample with some background fluorescence, it is observed that the baseline on which the Raman spectrum sits is not a flat line. The features in the baseline (e.g., its lack of ideal flatness) have a characteristic that is due in part to the optical components and detectors that comprise the system used for the measurement.

A number of methods may be used in determining the instrument response function of an optical instrument. For example, measurement of the instrument response function of an optical spectroscopy system may be made using a standard sample obtained from the National Institute of Standards and Technology (NIST), USA. Such a measurement is therefore traceable to that organization (i.e., NIST) in terms of validation. The NIST Raman standard (SRM 2242) may take the place of the ideal light source in the example discussed above because the NIST standard has a predictable relative number of photons that are emitted as a function of Raman shift (RS) values.

When response function of an optical spectroscopy instrument is measured using the NIST Raman standard, it is desirable to device an approach in which the field of view of the focal plane (of the spectroscopy instrument) is more homogeneous, allowing for a correction of spatial variations across the image field of view in the spectroscopy instrument.

### SUMMARY

In one embodiment, the present disclosure related to a method that comprises obtaining a NIST standard sample having a first surface and a second surface, wherein the first surface is smoother than the second surface and is located opposite to the second surface. The method further comprises placing the first surface to face a light collection optics in an optical spectroscopy instrument when determining an instrument response function of the spectroscopy instrument.

In another embodiment, the present disclosure relates to an improvement in a method to correct instrument response of an optical spectroscopy instrument using a NIST standard simple having a predetermined spectral characteristic and a first surface smoother than a second surface thereof and located opposite to the second surface. The improvement comprises placing the first surface instead of the second surface of the NIST sample to face a light collection optics in an optical spectroscopy instrument when determining an instrument response function of the spectroscopy instrument.

In a further embodiment, the present disclosure contemplates a method that comprises the following steps: (i) calibrating an optical spectroscopy instrument; (ii) bias-correcting the optical spectroscopy instrument; (iii) obtaining a NIST standard sample having a predetermined spectral characteristic and a first surface smoother than a second surface thereof and located opposite to the second surface; (iv) mathematically calculating a first spectrum of the NIST sample; (v) placing the first surface to face a light collection optics in the spectroscopy instrument; (vi) illuminating the first surface of the NIST sample with a photon source in the spectroscopy instrument and collecting photons scattered from the first surface using the light collection optics; (vii) measuring a second spectrum of the NIST sample from the collected scattered photons; (vii) smoothing the measured second spectrum; (ix) normalizing the first spectrum and the smoothed measured second spectrum; (x) determining an instrument response function of the spectroscopy instrument by dividing the normalized smoothed measured second spectrum by the normalized first spectrum; and (xi) saving the instrument response function in an electronic memory.

In yet another embodiment, the present disclosure contemplates an optical spectroscopy system. The system comprises a platform to hold a NIST standard sample to be used to determine an instrument response function of the spectroscopy system, wherein the NIST sample has a first surface that is another than a second surface thereof and located opposite to the second surface. The system further comprises an illumination source to illuminate the first surface with a first plurality of photons; a light collection optics to collect a second plurality of photons scattered from the first surface when illuminated by the illumination source; and a spectrometer coupled to the light collection optics to receive the collected second plurality of photons therefrom and to measure a first spectrum of the NIST sample from the received photons.

In one embodiment, the present disclosure relates to correction of instrument response of an optical spectroscopy instrument using a Raman standard sample supplied by NIST. The smoother side of the NIST sample is placed facing a light collection optics in the spectroscopy instrument, whereas the non-smooth or rough side remains away from the light collection optics, but in contact with a platform or sample placement surface in the spectroscopy instrument. An instrument response function is determined with the NIST sample so placed. Thereafter, spectra or spectral images of target samples obtained using the spectroscopy instrument are divided by the instrument response function to correct for imperfections in the response of the optical spectroscopy instrument. When the smoother side of the NIST sample faces the light collection optics in the spectroscopy instrument, the field of view of the focal plane (of the spectroscopy instrument) is more homogeneous, allowing for a correction of spatial variations across the image field of view in the spectroscopy instrument. The target sample spectra may be non-Raman spectra. The optical spectroscopy instrument may be a gratings-based or a tunable filter based spectroscopic imaging system.

### BRIEF DESCRIPTION OF THE DRAWINGS

For the present disclosure to be easily understood and readily practiced, the preset disclosure will now be described for purposes of illustration and not limitation, in connection with the following figures, wherein:

FIG. 1 shows exemplary Raman images of rough and smooth sides of a NIST standard sample;

FIG. 2 illustrates a simplified view of an exemplary instrumental set-up in which the NIST standard sample may be placed during calculation of an instrument response function according to one embodiment of the present disclosure;

FIG. 3 shows the spectra of the NIST standard sample measured using three different objectives (not shown) along with the calculated spectrum of the NIST standard sample according to one embodiment of the present disclosure;

FIG. 4 illustrates an exemplary plot of an instrument response function calculated according to one embodiment of the present disclosure;

FIG. 5 shows a comparison of two spectra of a fluorescent target sample wherein the top spectrum is obtained using the instrument response correction based on the NIST Raman standard SRM 2242, whereas the bottom spectrum is obtained by using the smoothed measured initial fluorescence spectrum of the target sample as the instrument response correction function;

FIG. 6 illustrates three exemplary plots of an instrument response function of a FALCON II™ system depicting changes in the instrument response function of the system over a period of two months of normal operation;

FIG. 7 depicts an exemplary instrument response function of a dispersive spectroscopic imaging system in comparison with an exemplary instrument response function of an LCTF-based spectroscopic imaging system; and

FIG. 8 illustrates an exemplary set of spectra illustrating the image correction results obtained using the smoother side of the NIST sample according to one embodiment of the present disclosure.

### DETAILED DESCRIPTION

The accompanying figure and the description that follows set forth the present disclosure in embodiments of the present disclosure. However, it is contemplated that persons generally familiar with optics, operation and maintenance of optical instruments (including spectroscopic instruments), or optical spectroscopy will be able to apply the teachings of the present disclosure in other contexts by modification of certain details. Accordingly, the figures and description are not to be taken as restrictive of the scope of the present disclosure, but are to be understood as broad and general teachings. In the discussion herein, when any numerical range of values is referred, such range is understood to include each and every member and/or fraction between the stated range of minimum and maximum.

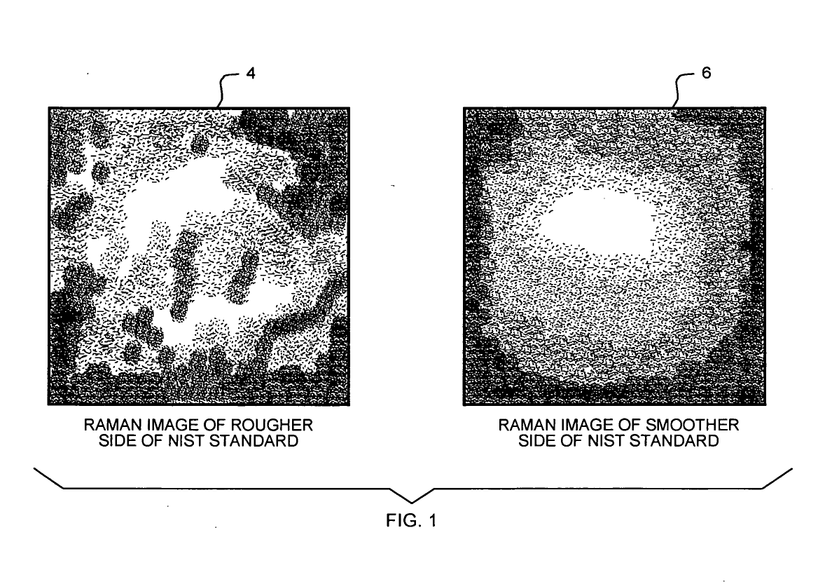

FIG. 1 shows exemplary Raman images of rough ad smoothed sides of a NIST standard sample (SRM 2242). In FIG. 1, the image of the rougher side is identified by reference numeral “4” and the image of the smoother side is identified by reference numeral “6.” The images 4, 6 were obtained using the FALCON II™ chemical spectroscopy and imaging system from ChemImage Corporation of Pittsburgh, Pa. It has been observed that during spectral data acquisition to measure the instrument response function of an optical spectroscopy instrument, when the smoother side of the NIST Raman standard (SRM 2242) faces the light collection optics in the spectroscopy instrument, the field of view of the focal plane (of the spectroscopy instrument) is more homogeneous, allowing for a correction of spatial variations across the image field of view in the spectroscopy instrument. In contrast, use of the rougher side of the sample (as recommended by NIST) leads to a field of view image with significant spatial variations, making it difficult (and, sometimes, impossible) to correct for variations in the spectroscopy apparatus across the field of view.

It is noted at the outset that the terms “NIST Raman standard sample,” “NIST standard,” “NIST sample”, etc., are used interchangeably herein to refer to the NIST Raman standard sample known as NIST SRM 2242.

The discussion below proceeds with an explanation of a method for measuring the instrument response function of an optical spectroscopy system using the NIST Raman standard sample. The steps involved in measuring an instrument response function include: (1) calculation of the Raman spectrum of the sample (i.e., the NIST standard sample) based on NIST documentation, (2) calibration of the instrument being characterized using standard methods known in the art, (3) measurement of the spectrum of the standard material (i.e., the NIST standard sample) on the calibrated instrument, and (4) calculation of the instrument response function. It is noted here that the foregoing steps need not be performed in the order given above. For example, step (2) can be performed before step (1), or step (1) can be performed after step (3), etc. Steps (1), (3) and (4) above are discussed in more detail below.

Calculation of Raman Spectrum Based on NIST Standard: The NIST standard that may be used to calibrate a 532 nm laser based Raman spectroscopy or chemical imagining system is called NIST SRM 2242. The sample (a piece of glass) can be obtained from NIST. Along with the standard, NIST produces a standard certificate of analysis that describes the Raman scattering characteristics of the sample. Part of this description is a set of coefficients and equations for calculating the Raman spectrum of the NIST sample material. The calculation as per the teachings in the NIST certificate may be carried out in a straight forward manner by one skilled in the art to accurately replicate the carefully measured spectrum NIST has obtained. It is noted, however, that the NIST certificate does not provide a description to calculate the Raman scattering based on the physics of the material. Once calculated, it may be desirable to format the Raman spectrum to be consistent with the data storage file format in use. For example, when the “.spc” file format is used for spectral data storage, the spectrum may be formatted to this “.spc” file format with ChemAnalyze™ 6.0 software designed by ChemImage Corporation of Pittsburgh, Pa. The illumination wavelength was set to 532.199 nm (≈532 nm) as used in the NIST certificate.

Measurement of the Spectrum of the NIST Standard Material: Before measuring the Raman spectrum of the NIST standard material, it is desirable that the spectroscopy instrument (whose instrument response is to be corrected) be calibrated using a method known in the art. One such method is to measure the Raman scattered light from a sample with known Raman scattering properties (several such samples are listed in ASTM standard E 1840 “Standard Guide for Raman Shift Standards for Spectrometer Calibration”) with the spectroscopy instrument to be calibrated. The spectroscopy system may have an associated method for translating measurements of light into an intensity as a function of Raman shift (RS) values. The spectroscopy system may include a dispersive element (typically an optical grating), which disperses collected light over an array detector (typically a CCD camera). Intensity values as a function of spatial position (pixels) on the detector may be measured. Based on the knowledge of where Raman shift peaks should appear for the material from which the scattered light is collected, a mapping from detector (here, a CCD) pixels to Raman shift in units of wavenumbers can be developed and recorded. Because such mapping depends on the optics of the system under calibration, the system can be then used to measure optical data (e.g., spectroscopic data) from other samples. A system in such a state of operation is said to be calibrated.

After calibration, measurement of the spectrum of the NIST standard sample may be performed by placing the smoother surface of the sample on the instrument stage and getting the sample in the focal plane of the spectroscopy instrument whose instrument response function is to be determined. However, before acquiring a spectrum of the reference material (here, the NIST standard SRM 2242), it may be desirable to ensure that the spectroscopy instrument under evaluation is working in a bias corrected fashion. In one embodiment, bias correction status may be confirmed by collecting a spectrum when the instrument's laser is off. If the instrument is bias corrected appropriately, the collected spectral intensities will fluctuate around zero. When the collected spectral intensities do not fluctuate around zero, the instrument may not be bias corrected. If the instrument is not bias corrected, then the spectrum just acquired may be used as a spectrum to be subtracted later from the spectral data for the measured raw spectrum (of the NIST standard sample).

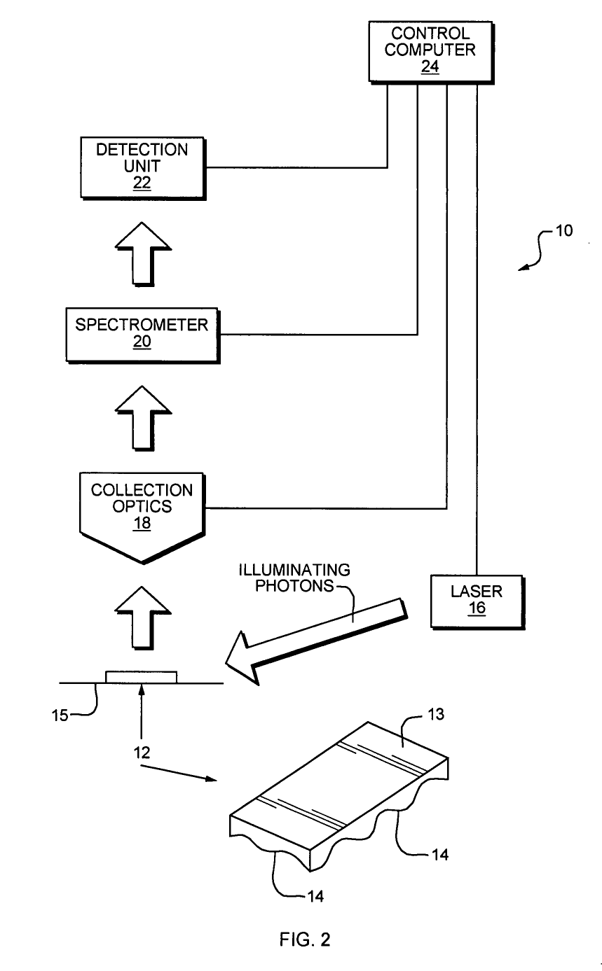

FIG. 2 illustrates a simplified view of an exemplary instrumental set-up in which the NIST standard sample may be placed during calculation of an instrument response function according to one embodiment of the present disclosure. The spectroscopic instrument 10 in the embodiment of FIG. 2 may include a sample placement surface or platform 15 on which the NIST standard sample 12 may be placed with its smoother side 13 facing a signal collection optics 18 as illustrated in FIG. 2. A portion of the sample 12 is shown in an enlarged view in FIG. 2 to illustrate that the smoother side 13 of the NIST standard sample is placed in proximity with the collection optics 18, whereas the rough side 14 is placed, for example, on the sample placement platform 15 (which can be a sample tray or any other surface for placing the sample for optical investigation)—away from the collection optics 18. It is noted here that the enlarged view of the NIST sample surfaces in FIG. 2 is for illustration only, and is neither drawn to scale nor does it accurately depict the actual surface geometry. It is seen that the rough side 14 of the NIST sample 12 is located opposite to the smoother side 13 of the sample 12. It is noted here that the enlarged depiction in FIG. 2 is for illustration only, and should not be construed to represent actual surface geometry of a NIST Raman standard sample. Furthermore, it is evident to one skilled in the art that the depiction in FIG. 2 is of highly simplified nature. In practice, a spectroscopic or chemical imaging instrument may contain many more other components than those illustrated in FIG. 2. These additional components or layout details are omitted in the simplified illustration in FIG. 2 for the sake of simplicity and ease of discussion only.

An illumination source 16 may be used to illuminate the smoother side 13 of the NIST sample 12 with photons of selected illumination wavelength. In one embodiment, the illumination source is a 532 nm laser. Other suitable wavelengths of laser illumination source may be employed as per system design. Any other suitable illumination source (e.g., an LED (light emitting diode) or an OLED (Organic LED)) having a narrow emission line suitable for measurement of Raman scattering may also be selected depending on the configuration of the spectroscopic instrument. The signal collection optics 18 (which may include one or more focusing lenses, optical filters, etc.) may collect the photos scattered by the NIST Raman sample 12 when illuminated by the illumination source 16. A spectrometer 20 may be optically coupled to the signal collection optics 18 to receive the collected scattered photons therefrom and to measure the spectrum of the NIST Raman sample from the received photons. In one embodiment, the spectrometer 20 is a gratings-based dispersive spectrometer. In the embodiment of FIG. 2, a detection unit 22 is shown optically coupled to the dispersive spectrometer 20 to receive the dispersed optical signals therefrom and to responsively generate one or more spatially accurate wavelength resolved images of the NIST standard sample 12. In one embodiment, the detection unit 22 is a CCD detector or a CCD camera. In the embodiment of FIG. 2, a control computer or control unit 24 is shown to control various system components including, for example, the detection unit 22, the spectrometer 20, and the laser illumination source 16. In one embodiment, the control unit 24 is a suitably-programmed computer, which may be configured to interact with a user to receives user inputs and accordingly control operations of various optical components in the spectroscopic instrument 10 to carry out the desired spectral data collection, spectral imaging, or other optical data processing task.

Thus, as illustrated in FIG. 2, the smoother side 13 of the NIST Raman sample may be placed facing the signal collection optics 18 inside the spectroscopic instrument 10 during measurement of the spectrum of the NIST standard. In contrast, NIST recommends using the rough side 14 to face the signal collection optics 18 whereas placing the smoother side 13 on the sample platform 15. Therefore, the present disclosure relates to a spectrum measurement approach that is contrary to the recommendations of NIST. However, as noted before, the use of the smoother side of the NIST sample for optical data collection as per the teachings according to one embodiment of the present disclosure may provide a more homogeneous field of view of the focal plane (of the spectroscopy instrument), thereby allowing for a correction of spatial variations across the image field of view in the spectroscopy instrument when spectral images of samples (including the NIST standard sample) are taken as discussed later hereinbelow.

For measurement of the spectrum of the NIST standard, in one embodiment, it may be desirable to select a laser power, acquisition time and averages consistent with a high signal to noise spectrum that spans the dynamic range of the photon detector (here, the CCD detector 22 in FIG. 2). In one embodiment, the dynamic range of the CCD detector 22 may have maximum counts of about 600000. In another embodiment, typical parameter values are: laser power at the head of the laser illumination source 16 (FIG. 2) may be 60 mW, the optical signal collection optics 18 may be a 50× object, the CCD data acquisition time may be 1 second, and the number of averages may equal to 60 (i.e., values of 60 spectra may be averaged to obtain final spectral measurements of the NIST standard).

Thus, using the system of FIG. 2 as discussed hereinbefore, a high quality spectrum of the NIST standard sample 12 may be acquired and saved. The measured spectrum of the NIST sample 12 may be saved in an electronic memory (e.g., the memory of the control computer 24 in FIG. 2) for future retrieval.

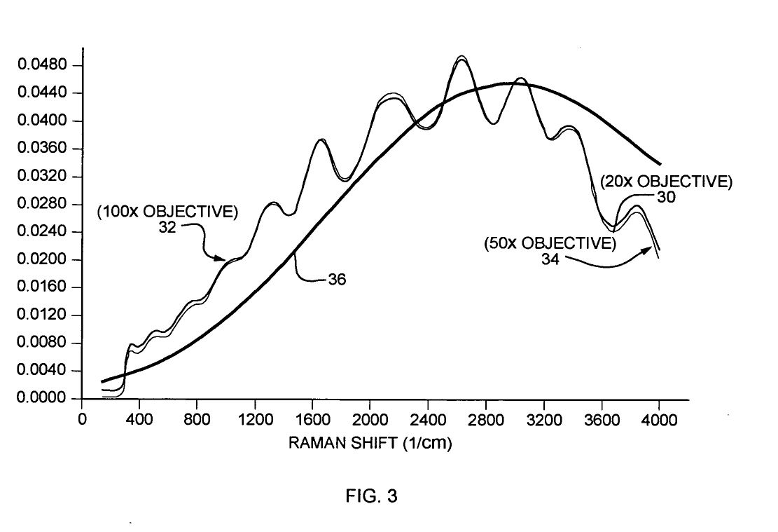

It is noted that, for the most part, the measured spectrum of the NIST standard sample (and, hence, the instrument response function derived from that measured spectrum as discussed later hereinbelow) may be independent of the objectives (a part of light collection optics in an optical instrument) used to make the spectral data measurements, especially when the objectives are supplied by a common source or vendor. There may be a small difference between spectra measured using different objectives even from the same vendor, but it may be probably insignificant, especially after baseline correction is performed. On the other hand, different optical configurations with objectives from different supplies may exhibit different instrument response functions. In that latter case, each instrument-specific instrument response function may need to be measured. FIG. 3 shows the spectra 30, 32, 34 of the NIST standard sample measured using three different objectives (not shown) along with the calculated spectrum 36 of the NIST standard sample according to one embodiment of the present disclosure. As discussed before, the calculated spectrum 36 may be obtained by performing the calculations specified in the NIST standard certificate of analysis accompanying the sample. On the other hand, the measured spectra may be obtained as discussed before in conjunction with the discussion of FIG. 2. It is noted that the spectra 30, 32, 34 may be measured using three different objectives in, for example, the signal collection optics 18 in the spectroscopic instrument 10 in FIG. 2. In the embodiment of FIG. 3, the spectra 30, 32, 34 were obtained using the FALCON II™ chemical spectroscopy and imaging system from ChemImage Corporation of Pittsburgh, Pa. After each measurement, the current objective may be replaced with another objective to measure the new spectrum. It is seen from the similarity among spectra 30, 32, 34 in FIG. 3 that the selection of objectives does not have any meaningful effect on the measured spectrum of the NIST standard sample.

Calculation of the Instrument Response Function: After obtaining the calculated spectrum and the measured spectrum of the NIST Raman standard, the instrument response function of the spectroscopic instrument 10 (FIG. 2) may be calculated as described herein. It is initially observed that in order to make the calculation of the instrument response function accurate, it may be desirable that the measured spectrum (of the NIST standard sample) be corrected for bias at each pixel (e.g., in the CCD detector 22 in FIG. 2). This can be done automatically during spectral data acquisition (e.g., using the instrument 10 in FIG. 2), or by subtracting a bias spectrum from the measured raw spectrum as mentioned in paragraph [020] hereinbefore.

Furthermore, as part of calculating an accurate instrument response function, it may be desirable to normalize both the measured (bias corrected) spectrum and the actual spectrum (i.e., the calculated spectrum) of the NIST Raman standard by making the area under the respective spectral curves (representing the integrated intensity of the signal) equal. One skilled in the art may appreciate that vector normalization may be used to achieve this.

It is noted here that the measured spectrum, S_{measured}, may be related to the real (i.e., calculated) spectrum of the NIST standard sample, S_{actual}, by the instrument response function, Sᵣₑₛₚₒₙₛₑ, as follows:
S_{measured}=S_{actual}*Sᵣₑₛₚₒₙₛₑ (1)
Thus,
Sᵣₑₛₚₒₙₛₑ=S_{measured}/S_{actual} (2)
It is seen from equation (2) above that the instrument response function of an optical instrument (e.g., a spectroscopic instrument) may be calculated by dividing the measured spectrum of the NIST standard sample by the actual spectrum of the sample calculated based on the NIST instructions. It is observed than the instrument response function calculated in this fashion has a value near one (ranging from 0.8 to 1.2 over most of the relevant spectral range). This may mean that this correction can be used without losing information about signal strength during spectral data acquisition by the spectroscopic instrument.

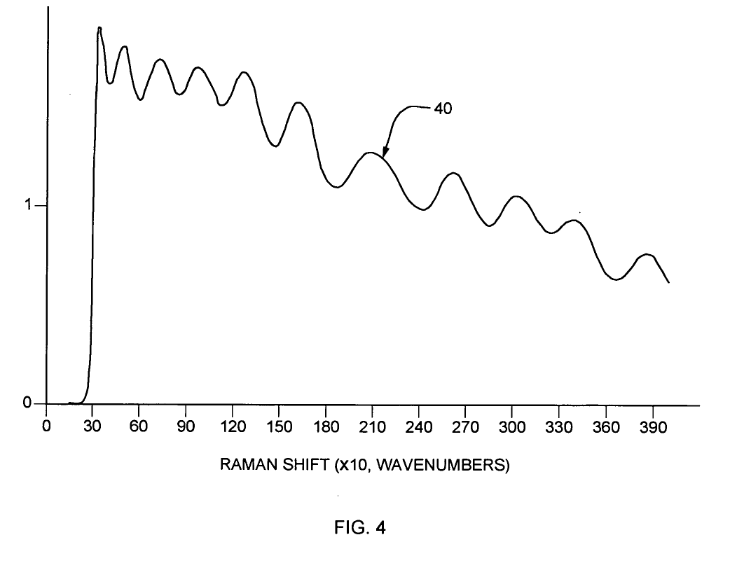

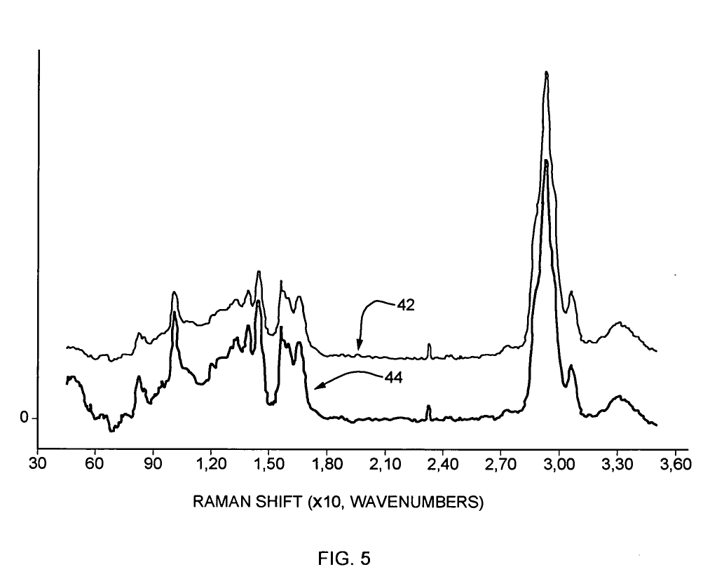

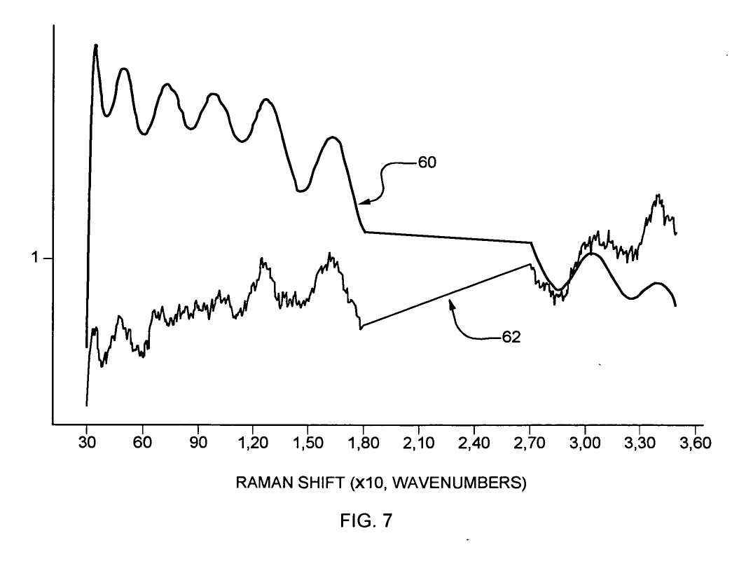

FIG. 4 illustrates an exemplary plot 40 of an instrument response function calculated according to one embodiment of the present disclosure. The plot 40 in FIG. 4 represents instrument response function of a FALCON II™ chemical spectroscopy and imaging system from ChemImage Corporation of Pittsburgh, Pa. The instrument response function 40 is calculated using equation (2) given above, where one of the spectra 30, 32, or 34 (in FIG. 3) is used as S_{measured}, and the spectrum 36 (in FIG. 3) is used as S_{actual}. It is observed here that the Raman shift values on the x-axis in the plot in FIG. 4 (and, also in FIGS. 5 and 7 discussed below) should be multiplied by 10 to obtain the actual RS values or wavenumbers as indicated.

Using Calculated Instrument Response Function to Acquire or Process Data: Once calculated, the instrument response function may be stored in an electronic memory as mentioned before. The stored instrument response function can then be used to automatically correct for wavelength dependent transmission pattern of an optical instrument during measurement of spectra or spectral images from a target sample (i.e., a sample other than the NIST standard sample). It is seen from equation (b 1) above that it relates a measured spectrum to the actual spectrum of a sample material via the instrument's response function.

Thus, from equation (1), one obtains:
S_{actual}=S_{measured}/Sᵣₑₛₚₒₙₛₑ (b 3)
From the above equation (3), it is seen that to get the actual spectrum (corrected for instrument response) of a target sample, the bias corrected measured spectrum of that sample must be divided by the instrument response function. This division can be performed on the fly using an automated correction scheme. It is noted here that an instrument's response function is only certified by NIST between 150 and 4000 wavenumber, and, hence, in one embodiment, truncation of the results to at least this region (of wavenumbers) is performed.

Summary of Procedure for Measuring and Applying an Instrument Response function: The foregoing discussion of measurement of an instrument response function using a NIST Raman standard sample and application of the measured instrument response to a target sample may be summarized as following steps: (i) calibrate the spectroscopic instrument whose instrument response function is to be determine; (ii) bias-correct the spectroscopic instrument; (iii) calculate a spectrum of the NIST SRM 2242 Raman standard; (iv) measure a spectrum of the NIST standard sample and, optionally, smooth the measured spectrum; (v) interpolate smoothed measured spectrum onto calculated spectrum of NIST sample; (vi) normalized both spectra (i.e., measured and calculated spectra of the NIST sample); (vii) divide the normalized smoothed measured spectrum by the normalized calculated spectrum; (viii) save the result of the division as the instrument response function; and (ix) use the saved instrument response function to correct for instrument response in a subsequent measurement, which may include (a) acquisition of a bias corrected spectrum of a target sample (which may not be a NIST standard), (b) division of the acquired target spectrum by the stored instrument response function to obtain the actual spectrum of the target, and (c) any further processing of various optical data as desired.

It is noted here that the steps mentioned in the preceding paragraph need not be performed in the order specified herein. As mentioned before, some steps may be performed in different order. Furthermore, some steps may be optional and, hence, may be omitted if so desired. For example, the smoothing of the measured spectrum of the NIST Raman sample or the interpolation of the measured and calculated spectra may be omitted if resultant performance deficiencies can be acceptable to the user.

FIG. 5 shows a comparison of two spectra of a fluorescent target sample (not shown) wherein the top spectrum 42 is obtained using the instrument response correction based on the NIST Raman standard SRM 2242, whereas the bottom spectrum 44 is obtained by using the smoothed measured initial fluorescence spectrum of the target sample as the instrument response correction function. The initial fluorescence spectrum of the target sample may be obtained by collecting those initial fluorescence emissions from the sample that occur substantially immediately after the sample is first illuminated by an illumination source in the spectroscopic instrument. In one embodiment, any subsequent photon emissions from the sample (e.g., over a period of time) may not be considered as “initial” fluoresce emissions. The spectras 42, 44 in FIG. 5 were obtained using the FALCON II™ chemical imaging system mentioned hereinbefore. The similarities and differences between the two spectra 42, 44 obtained using two different approaches are clearly visible in FIG. 5.

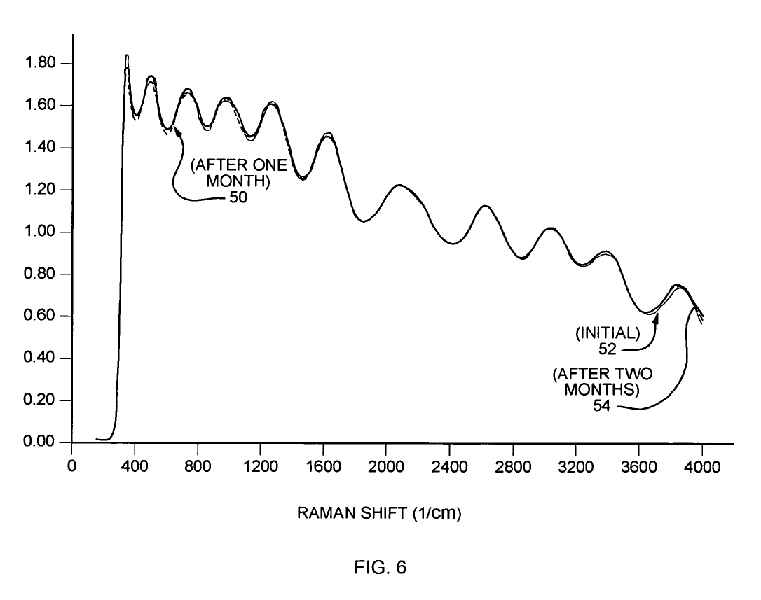

FIG. 6 illustrates three exemplary plots 50, 52, 54 of an instrument response function of a FALCON II™ system (available for ChemImage Corporation of Pittsburgh, Pa.) depiciting changes in the instrument response function of the systems over a period of two months of normal operation. Each of the plot in FIG. 6 was measured on three different occasions over the period of two months. Furthermore, none of the plots was normalized or scaled to improve the overlay. From the plots 50, 52, 54 in FIG. 6, it is seen that the instrument response function of the Falcon II™ system remained relatively stable with subjectively little variation over months.

In one embodiment, the present disclosure relates to correction of a spectral image of a target sample instead of correction of a spectrum of the target sample as discussed hereinbefore. The spectral image may be obtained using a spectroscopic imaging device. The correction may be carried out by using the device's instrument response function calculated using the NIST Raman standard as per the methodology discussed hereinbefore. The spectral image may be obtained using an LCTF (Liquid Crystal Tunable Filter) based spectroscopic imaging system, a grating based (dispersive) spectroscopic imaging system, or a computed topographic imaging spectrometer (CTIS). For example, in the embodiment of FIG. 2, the spectrometer 20 was mentioned as a gratings-based dispersive spectrometer. However, in one embodiment, the system of FIG. 2 may be modified to include on LCTF-based spectrometer (not shown) or a CTIS spectrometer in addition to or instead of the gratings-based spectrometer 20. In a fashion similar to that described above. LCTF based Raman spectroscopic imaging can be corrected for instrument response. Because the LCTF may be less stable over time than the fixed solid optics of the rest of the imaging system, it may be necessary to perform the NIST based correction more frequently, perhaps with every measurement.

It is noted here that, for the sake of brevity, the discussion below focuses on correction of LCTF based spectral images of a target sample. However, the methodology discussed hereinbelow may be equally applied by one skilled in the art to correct spectral images obtained using a dispersive spectroscopic imaging system.

In one embodiment, the procedure of NIST-based instrument response correction in case of an LCTF-based system mirrors the procedure discussed above, wherein the smooth side of the NIST standard is used facing the light collection optics to determine instrument response function as per the teachings of the present disclosure. Briefly, the procedure for the LCTF-based spectroscopic imaging instrument may be performed as follows: (i) acquire an LCTF-based image of a target sample; (ii) place the smooth side of the NIST standard in the focal plane of the objective in the imaging instrument; (ii) acquire an LCTF-based image of the NIST Raman standard (i.e., NIST SRM 2242) with the same spectral stops of the NIST standard as those in the LCTF image of the target sample; (iv) calculate the Raman spectrum of the NIST standard; (v) use the NIST standard measurement and the calculated spectrum of the NIST standard to generate an instrument response function for the instrument that uses the LCTF for spectroscopy and spectral imaging; and (vi) divide the target image by the instrument response function to obtain the actual image of the target sample. In one embodiment, the target image and the instrument response for a spectral imaging system may be in the form of a 3-dimensional (3D) data cube with spatial (x, y) and spectral (λ) dimensions. In that case, the division in step (vi) may be performed by dividing each data point from the target image. Data_{target}(x,y,λ), by the respective data point in the instrument response data cube, Data_{Instrument Response}(x,y,λ). This method of division may work in cases: (a) where the data points for all x,y positions for a given lambda (λ) are identical (as, for example, when using the mean spectrum from the target image to calculate the instrument response function), and (b) where the data points for all x,y, positions for a given lambda (λ) are identical (as in the case when the spectrum extracted from each pixel of the measured image from the NIST standard is used independently to generate the instrument response data cube). It is mentioned here that one skilled in the art may chance the order of performance of some of the steps as desired. For example, step (iv) above may be performed prior to step (i), or after step (i) but prior to step (ii), etc. In one embodiment, step (i) may be performed after steps (ii) through (v), but before step (vi). In that case, the number of spectral stops may be determined from the earlier-obtained image of the NIST Raman standard.

FIG. 7 depicts an exemplary instrument response function 60 of a dispersive spectroscopic imaging system in comparison with an exemplary instrument response function 62 of an LCTF-based spectroscopic imaging system. In the embodiment of FIG. 7, the FALCON II™ system from ChemImage Corporation of Pittsburgh, Pa., has been used as both the dispersive as well as the LCTF-based spectroscopic imaging system. However, in another embodiment, different systems may be used instead of a single system having both of the functionalities. It is observed from the plots 60, 62 in FIG. 7 that instrument response function of an LCTF-based system is different from that of a dispersive system, and may be not as smooth as the response of the dispersive system.

The following approaches may be considered during NIST-based correction of an LCTF based spectroscopic imaging device. In one embodiment, the NIST-based correction process may be made easier if a user-function based macro is written in software to perform the necessary operations given the target image and the image from the NIST standard. The software macro may automatically compute the instrument response function and may also apply the instrument response function to the target image to obtain the actual image of the target sample.

In another embodiment, it may be preferable to correct the images of both the target and the NIST sample for CCD chip bias in the detection unit 22 (FIG. 2). Such correction can either be done as part of the spectral data acquisition or after the data are acquired. In case of availability of the user-function macro as mentioned above, the correction may not be included in the user-function. That is, the user-function may assume that this correction was done before the user-function was called.

It is observed here that the NIST-based correction methodology discussed hereinbefore may use the average spectrum acquired from the plurality of LCTF images (obtained at a corresponding plurality of, for example, Raman shift values or wavenumbers) of the NIST standard, and not the spectrum for each pixel position (in the detection unit) independently. In other words, for each LCTF image (e.g., at a specific Raman shift value or wavenumber) containing “n” pixel positions, an average pixel intensity value may be obtained for that image by averaging intensity values from “n” pixel positions. All such average pixel intensity values for corresponding LCTF images may be combined to generate the average spectrum of the LCTF images of the NIST sample. In one embodiment, this average NIST spectrum may be used to derive the instrument response function, which can be then applied to the LCTF image of the target sample as mentioned hereinbefore. The target LCTF image may be a composite image generated by combining a plurality of LCTF images of the target sample obtained at various Raman shift (RS) values or wavenumbers. In an alternative embodiment, a plurality of LCTF images of the target sample may be obtained and, from that, an average spectrum of the target sample can be derived (e.g., the spectrum of the composite LCTF image of the target sample). This average target spectrum may be then divided by the instrument response function to obtain an instrument response-corrected or actual spectrum of the target. It is observed here that the number of pixel positions in a target LCTF image may be the same or different from the number of pixel positions in an LCTF image of the NIST sample. In that case, appropriate pixel mapping may be carried out to preserve pixel position correspondence.

In one embodiment, pixel by pixel correction may be implanted. Instead of using the average spectrum of the LCTF images acquired from the NIST standard, the pixel-by-pixel correction may be carried out by performing the same mathematical operations on the spectrum recorded at each pixel position across the plurality of LCTF images of the NIST standard. In this approach, a pixel position-specific instrument response function can be derived by dividing each pixel position-specific spectrum across the plurality of LCTF images of the NIST sample by the mathematically calculated spectrum of the NIST sample. Thereafter, spectral intensity value at each pixel position in an LCTF image of a target sample may be divided by the corresponding pixel position-specific instrument response function to obtain a pixel position-specific instrument response-corrected image of the target sample. In case of a plurality of LCTF images of the target sample, each spectrum associated with a corresponding pixel position across the plurality of target LCTF images may be divided by the corresponding pixel position-specific instrument response function. The pixel-by-pixel correction approach may allow for correction of both spatial variations and wavelength dependent transmission artifacts in the spectral data for the target sample.

In one embodiment, the NIST standard may be placed in a DIC (Differential Interference Contrast) slot in a microscope when performing instrument response correction thereof.

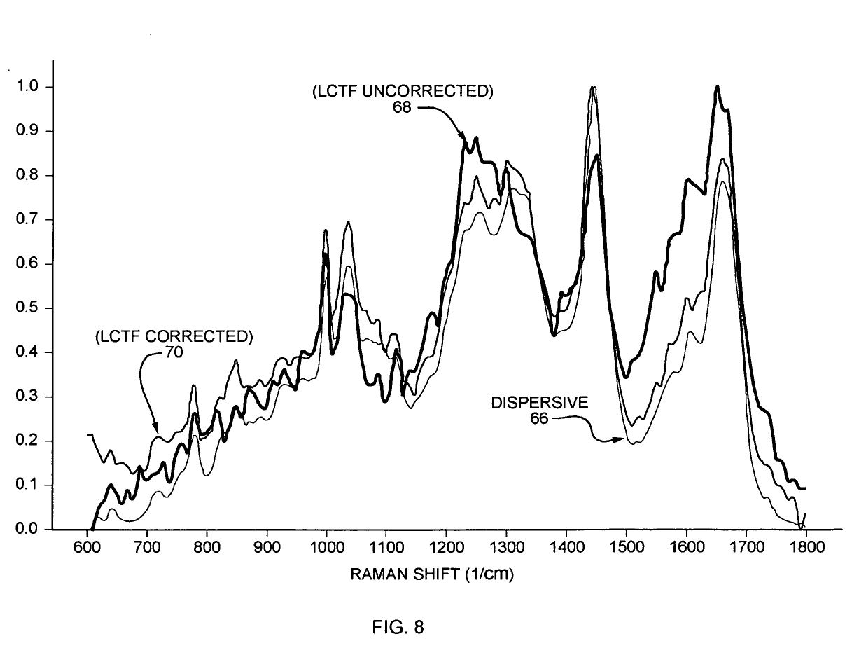

FIG. 8 illustrates an exemplary set of spectra 66, 68, 70 illustrating the image correction results obtained using the smoother side of the NIST sample according to one embodiment of the present disclosure. In the embodiment of FIG. 8, the spectrum 66 represents a dispersive spectrum of a target sample obtained using the FALCON II™ system from ChemImage Corporation of Pittsburgh, Pa. The second spectrum 68 represents the image spectrum of an uncorrected composite LCTF image of the target sample. The composite LCTF image may be generated by combining a plurality of LCTF images of the target sample obtained at various Raman shift (RS) values or wavenumbers. An instrument response function was determined using the smoother side of the NIST Raman standard as per the teachings of one embodiment of the present disclosure. That instrument response function was then used to correct the uncorrected spectrum 68 as per the teachings of one embodiment of the present disclosure. The corrected image spectrum 70 is shown in FIG. 8. In the embodiment of FIG. 8, all spectra were baseline corrected (general, order 2) and normalized for proper comparison.

The foregoing describes a system and method for correction of instrument response of an optical spectroscopy instrument using a Raman standard sample supplied by NIST. The smoother side of the NIST sample is placed facing a light collection optics in the spectroscopy instrument, whereas the non-smooth or rough side remains away from the light collection optics, but in contact with a platform or sample placement surface in the spectroscopy instrument. An instrument response function is determined with the NIST sample so placed. Thereafter, spectra or spectral images of target samples obtained using the spectroscopy instrument are divided by the instrument response function to correct for imperfections in the response of the optical spectroscopy instrument. The target sample spectra may be non-Raman spectra. The optical spectroscopy instrument may be a gratings-based or a tunable filter based spectroscopic system.

It is noted here that although the discussion hereinabove is provided with reference to the NIST 2242 standard, the teachings of the present disclosure (including, for example, the use of a smoother side of a standardized sample for correction of instrument response) may also apply to other NIST standards developed and characterized in the same fashion. Furthermore, the instrument response correction methodology according to the teachings of one embodiment of the present disclosure may also apply to any other sample with a stable, predictable spectral response. The methodologies discussed herein may also work for other excitation wavelengths (e.g., wavelengths other than 532 nm) as long as the sample with the known spectral response has been characterized with that wavelength of excitation. Furthermore, the teachings of the present disclosure may be adapted to work with standards characterized by other entities such as European, Asian, Central American, or South American standards bureaus.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method comprising:
obtaining a NIST standard sample having a first surface and a second surface, wherein said first surface is smoother than said second surface and is located opposite to said second surface; and
placing said first surface to face a light collection optics in an optical spectroscopy instrument when determining an instrument response function of said spectroscopy instrument.

2. The method of claim 1, wherein said NIST sample has a predetermined spectral characteristic.

3. The method of claim 1, further comprising:
mathematically calculating a first spectrum of said NIST sample;
measuring a second spectrum of said NIST sample using said optical spectroscopy instrument; and
determining said instrument response function by dividing said second spectrum by said first spectrum.

4. The method of claim 3, further comprising performing the following prior to determining said instrument response function:
bias-correcting said second spectrum to account for bias of said topical spectroscopy instrument; and
normalizing said first spectrum and said bias-corrected second spectrum.

5. The method of claim 3, further comprising:
replacing and NIST standard sample with a target sample in said optical spectroscopy instrument;
measuring a third spectrum of said target sample using said spectroscopy instrument; and
dividing said third spectrum by said instrument response function to obtain an instrument response-corrected spectrum of said target sample.

6. The method of claim 5, wherein said measuring said third spectrum includes:
bias-correcting said third spectrum to account for bias of said optical spectroscopy instrument.

7. The method of claim 1, wherein said NIST standard sample is a NIST Raman standard sample SRM 2242.

8. The method of claim 1, wherein said optical spectroscopy instrument is an LCTF-based spectroscopic imaging device, wherein said method further comprises:
mathematically calculating a first spectrum of said NIST sample;
acquiring a first plurality of LCTF images of said NIST standard sample, wherein each of said first plurality of LCTF images contains a first plurality of pixel positions and a corresponding first plurality of spectral intensity values associated therewith;
averaging the corresponding first plurality of spectral intensity values in each of said first plurality of LCTF images, thereby obtaining a first plurality of averaged intensity values;
obtaining a second spectrum from said first plurality of averaged intensity values;
determining said instrument response function by dividing said second spectrum by said first spectrum;
replacing said NIST standard sample with a target sample in said optical spectroscopy instrument;
acquiring a second plurality of LCTF images of said target sample, wherein each of said second plurality of LCTF images contains a second plurality of pixel positions and a corresponding second plurality of spectral intensity values associated therewith;
averaging the corresponding second plurality of spectral intensity values in each of said second plurality of LCTF images, thereby obtaining a second plurality of averaged intensity values;
obtaining a third spectrum from said second plurality of averaged intensity values; and
dividing said third spectrum by said instrument response function to obtain an instrument response-corrected spectrum of said target sample.

9. The method of claim 8, wherein the total number of pixel positions in said first plurality of pixel positions is equal to the total number of pixel positions in said second plurality of pixel positions.

10. The method of claim 1, wherein said optical spectroscopy instrument is a spectroscopic imaging device, wherein said method further comprises:
mathematically calculating a first spectrum of said NIST sample;
acquiring a plurality of LCTF images of said NIST standard sample, wherein each of said plurality of LCTF images contains a plurality of pixel positions and a corresponding plurality of spectral intensity values associated therewith;
averaging the corresponding plurality of spectral intensity values in each of said plurality of LCTF images, thereby obtaining a plurality of averaged intensity values;
obtaining a second spectrum from said plurality of averaged intensity values;
determining said instrument response function by dividing said second spectrum by said first spectrum;
replacing said NIST standard sample with a target sample in said optical spectroscopy instrument;
acquiring a spectroscopic image of said target sample; and
dividing said spectroscopic image by said instrument response function to obtain an instrument response-corrected spectroscopic image of said target sample.

11. The method of claim 1, wherein said optical spectroscopy instrument is an LCTF-based spectroscopic imaging device, wherein said method further comprises:
mathematically calculating a first spectrum of said NIST sample;
acquiring a plurality of LCTF images of said NIST standard sample, wherein each of said plurality of LCTF images contains a plurality of pixel positions;
obtaining a plurality of pixel position-specific spectra corresponding to said plurality of pixel positions across said plurality of LCTF images of said NIST standard sample;
determining a pixel position-specific instrument response function for each of said plurality of pixel positions by dividing each pixel position-specific spectrum by said first spectrum;
replacing said NIST standard sample with a target sample in said optical spectroscopy instrument;
acquiring an LCTF image of said target sample, wherein said LCTF image of said target sample contains said plurality of pixel positions and a corresponding plurality of spectral intensity values associated therewith; and
dividing each of said plurality of spectral intensity values in said LCTF image of said target sample by a corresponding pixel position-specific instrument response function to obtain a pixel position-specific instrument response-corrected image of said target sample.

12. In a method to correct instrument response of an optical spectroscopy instrument using a NIST standard sample having a predetermined spectral characteristic and a first surface smoother than a second surface thereof and located opposite to said second surface, the improvement comprising:
placing said first surface instead of said second surface of said NIST sample to face a light collection optics in an optical spectroscopy instrument when determining an instrument response function of said spectroscopy instrument.

13. The method of claim 12, wherein the improvement further comprising:
calculating a first spectrum of said NIST sample;
illuminating said first surface of said NIST sample with a photon source in said spectroscopy instrument and collecting photons scattered from said first surface using said light collection optics;
obtaining a second spectrum of said NIST sample from said collected scattered photons; and
determining said instrument response function by dividing said second spectrum by said first spectrum.

14. A method comprising:
calibrating an optical spectroscopy instrument;
bias-correcting said optical spectroscopy instrument;
obtaining a NIST standard sample having a predetermined spectral characteristic and a first surface smoother than a second surface thereof and located opposite to said second surface;
mathematically calculating a first spectrum of said NIST sample;
placing said first surface to face a light collection optics in said spectroscopy instrument;
illuminating said first surface of said NIST sample with a photon source in said spectroscopy instrument and collecting photons scattered from said first surface using said light collection optics;
measuring a second spectrum of said NIST sample from said collected scattered photons;
smoothing said measured second spectrum;
normalizing said first spectrum and said smoothed measured second spectrum;
determining an instrument response function of said spectroscopy instrument by dividing said normalized smoothed measured second spectrum by said normalized first spectrum; and
saving said instrument response function in an electronic memory.

15. The method of claim 14, further comprising:
replacing said NIST sample with a target sample in said optical spectroscopy instrument;
measuring a third spectrum of said target sample using said spectroscopy instrument; and
dividing said third spectrum by said saved instrument response function to obtain an instrument response-corrected spectrum of said target sample.

16. An optical spectroscopy system, comprising:
a platform to hold a NIST standard sample to be used to determine an instrument response function of said spectroscopy system, wherein said NIST sample has a first surface that is smoother than a second surface thereof and located opposite to said second surface;
an illumination source to illuminate said first surface with a first plurality of photons;
a light collection optics to collect a second plurality of photons scattered from said first surface when illuminated by said illumination source; and
a spectrometer coupled to said light collection optics to receive said collected second plurality of photons therefrom and to measure a first spectrum of said NIST sample from said received photons.

17. The system of claim 16, further comprising:
a control unit configured to mathematically calculate a second spectrum of said NIST sample, wherein said control unit is coupled to said spectrometer to obtain said first spectrum therefrom, and wherein said control unit is further configured to divide said first spectrum and said second spectrum to determine an instrument response function of said optical spectroscopy system.

18. The system of claim 17, wherein said illumination source is configured to illuminate a target sample with a third plurality of photons when said target sample is placed on said platform, wherein said light collection optics is configured to collect a fourth plurality of photons emitted, reflected, transmitted, or scattered from the target sample when illuminated by said illumination source, wherein said spectrometer is configured to receive said collected fourth plurality of photons from said light collection optics and to measure therefrom a third spectrum of said target sample, and wherein said control unit is configured to obtain said third spectrum from said spectrometer and to divide said third spectrum by said instrument response function to generate an instrument response-corrected spectrum of said target sample.

19. The system of claim 16, further comprising:
a detection unit coupled to said spectrometer to receive a first optical output therefrom when said first surface of said NIST sample is illuminated and to receive a second optical output therefrom when a target sample other than said NIST sample is illuminated by said illumination source, wherein said detection unit is configured to facilitate generation of a first spatially accurate wavelength resolved image of and NIST sample from said first optical output and a second spatially accurate wavelength resolved image of said target sample from said second optical output.

20. The system of claim 19, wherein said detection unit includes a charge coupled device.

21. The system of claim 16, wherein said NIST standard sample is a NIST Raman standard sample SRM 2242.

22. The system of claim 16, wherein said spectrometer includes one of the following:
an LCTF-based spectrometer;
a gratings-based dispersive spectrometer; and
a computer topographic imaging spectrometer (CTIS).
